(19) United States
(12) Patent Application Publication
(10) Pub. No.: US 2002/0018488 A1
(43) Pub. Date: Feb. 14, 2002

(54) Transmission equipment having interface conversion function

(76) Inventors: Kazuhiro Ohnuma, Kawasaki (JP); Kazuyuki Fujiwara, Kawasaki (JP); Yukihiro Hayakawa, Kawasaki (JP); Tatsuya Uehara, Kawasaki (JP)

Correspondence Address: ROSENMAN & COLIN LLP, 575 MADISON AVENUE, NEW YORK, NY, 10022-2585, US

(21) Appl. No.: 09/775,159

(22) Filed: Feb. 1, 2001

(30) Foreign Application Priority Data
Aug. 14, 2000 (JP) 2000-245667

(51) Int. Cl. H04J 3/16; H04J 3/22; H04J 3/04; H04L 12/28

(52) U.S. Cl. 370/466; 370/404; 370/535

(57) ABSTRACT

Transmission system and equipment therefore are disclosed, by which independent network implementation corresponding to individual communication interfaces can be avoided. A network is constituted by a plurality of transmission equipment connected thereto. Each transmission equipment provides an interface which accommodates a plurality of low-speed main signal transmission lines respectively to transmit a main signal to the network according to the preset cross-connection, or to transmit, in the opposite direction, a main signal received from the network to the plurality of low-speed main signal transmission lines. The transmission equipment also provides an interface processor for converting formats corresponding to the main signal interfaces to a format commonly defined within the network.

### FIELD OF THE INVENTION

The present invention relates to transmission equipment having synchronous interface function, and a network system using the same.

### BACKGROUND OF THE INVENTION

Transmission systems synchronized throughout a network using clock from a clock source are widely used in various types. These systems can be classified into the following types.

In North America, there has been applied a unique new synchronous interface called SONET standard developed by Bell Communication Research (Bellcore). In other regions such as Australia, United Kingdom, China etc., a new synchronous system conforming to ITU-T standard has been adopted.

Furthermore, in Japan, another new synchronous system developed by Nippon Telegraph & Telephone Corporation (NTT) has been in use. This system is being adopted not only by NTT but by most new common carriers (NCCs) in Japan.

In recent years, submarine optical transmission networks have been introduced worldwide. In addition, independent NCCs operate various kinds of network interfaces, i.e. not only the Japanese conventional interface but also foreign interfaces, to cope with the explosive increase of the Internet traffic, etc. For these reasons, domestic network configuration becomes more complicated than ever.

In brief, all physical, logical and switchover interfaces of the aforementioned three network interfaces are now required in the domestic networks. This tendency will increase more remarkably considering the network business situation in the country.

Conventionally, most transmission equipment has been developed mainly considering line accommodation efficiency, with a fixed idea of introducing logical and switchover interfaces of NTT mentioned above.

In order to connect a domestic network to overseas networks, there has generally been applied a means of bringing in foreign equipment, dividing a higher-order group of foreign network interface directly to lower-order groups, and using DSU (ring transmission equipment or data circuit terminating equipment—hereinafter referred to as transmission equipment as a whole) etc. to fit to respective user interfaces.

In other words, because of difficulty in integrating domestic and foreign transmission equipment into one, independent network configuration has been required interface by interface. This directly results in large implementation cost. Therefore it has been a great issue to improve efficiency in network construction.

### SUMMARY OF THE INVENTION

It is therefore an object of the present invention to solve the above-mentioned inefficiency in the conventional networks.

In short, to cope with the above issue, the present invention has the following features:

First, there is provided a low-speed interface board for accommodating a plurality of main signal transmission lines (HWs), capable of handling interfaces of NTT interface, SONET interface and ITU-T interface. For this purpose, the low-speed interface board is configured so that any of the above three interfaces can be selected for each main signal transmission line (HW) by setting from control equipment (CPU).

Secondly, a low-speed interface board includes a plurality of HWs, each having two optical level property, i.e. high and low optical levels. Either of these optical levels can be set from the CPU on each main signal transmission line (HW) basis. This enables to set either an interoffice interface or an intraoffice interface.

Furthermore, a network system according to the present invention includes a plurality of transmission equipment connected to a network, wherein each said plurality of transmission equipment accommodating a plurality of low-speed main signal transmission lines provides; (1) an interface for transmitting the main signal to the network according to a preset cross-connection, or for transmitting the main signal received from the network to the plurality of low-speed main signal transmission lines; and, (2) an interface processor for converting a format of said main signal interface into a format common to the network.

Preferably, transmission equipment, which is connected to a network for use in a network system to accommodate a plurality of low-speed main signal transmission lines, provides an interface for transmitting the main signal to the network according to a preset connection of a cross-connect or for transmitting the main signal received from the network to the plurality of low-speed transmission lines, and an interface processor for converting a format of said main signal interface into a format common to the network.

Further, preferably transmission equipment connected to a network includes; an optical module for transmitting and receiving an optical main signal; an interface processor corresponding to a plurality of interfaces; a cross-connect for connecting a main signal to a predetermined connection line; and a CPU bus processor for supplying the interface processor with a setting signal to specify one of the plurality of interfaces for use, and also for supplying the cross-connect with a cross-connect signal to set the connection line of the main signal.

Still further, preferably transmission equipment supplies the interface processor with a level setting signal through the CPU bus for changing a light emission level of the optical module using the CPU bus processor through either intraoffice connection or interoffice connection.

Still further, preferably the interface processor in the transmission equipment includes; a main signal processor for converting a main signal with either serial-to-parallel or parallel-to-serial conversion function; a plurality of overhead input/output processors respectively corresponding to a plurality of interfaces, wherein said each plurality of overhead input/output processors convert a reference symbol having definition of use proper to each interface into a format commonly defined to the network.

Still further, preferably said plurality of interfaces include NTT interface, ITU-T interface and SONET interface.

Further scopes and features of the present invention will become more apparent by the following description of the embodiments with the accompanied drawings.

### BRIEF DESCRIPTION OF THE DRAWINGS

FIG. 1 shows a chart illustrating processing sequence on a transmission side and a receiving side in transmission equipment.

FIG. 2 shows an example of ring network configuration using transmission equipment having processing function in accordance with the present invention.

FIG. 3 shows a block diagram of transmission equipment.

FIG. 4 shows a block diagram of an embodiment of main signal processor 305.

FIG. 5 shows a signal frame configuration.

FIG. 6 shows a chart for comparing the specifications of the byte format between NTT for domestic use, ITU-T for general countries, and SONET in the USA.

FIG. 7 shows serial data transmitted from CPU bus processor 320 in order to set input/output processors 101, 102 or 103.

FIG. 8 shows a serial signal transmitted on the CPU bus.

FIG. 9 shows an example of the signal connection from the low-speed interface portion to high-speed interface portion located on the network side.

FIG. 10 shows an example of the signal transmission reverse to the case of FIG. 9, from the network side to low-speed interface portion 90.

FIG. 11 shows an example of turning a signal back to a low-speed transmission line.

### DETAILED DESCRIPTION OF THE PREFERRED EMBODIMENT

The preferred embodiment of the present invention is described hereinafter referring to the charts and drawings. It should be noted that the embodiment shown is described for the sake of understanding of the invention. The scope of the present invention must not be restricted to the description presented herein.

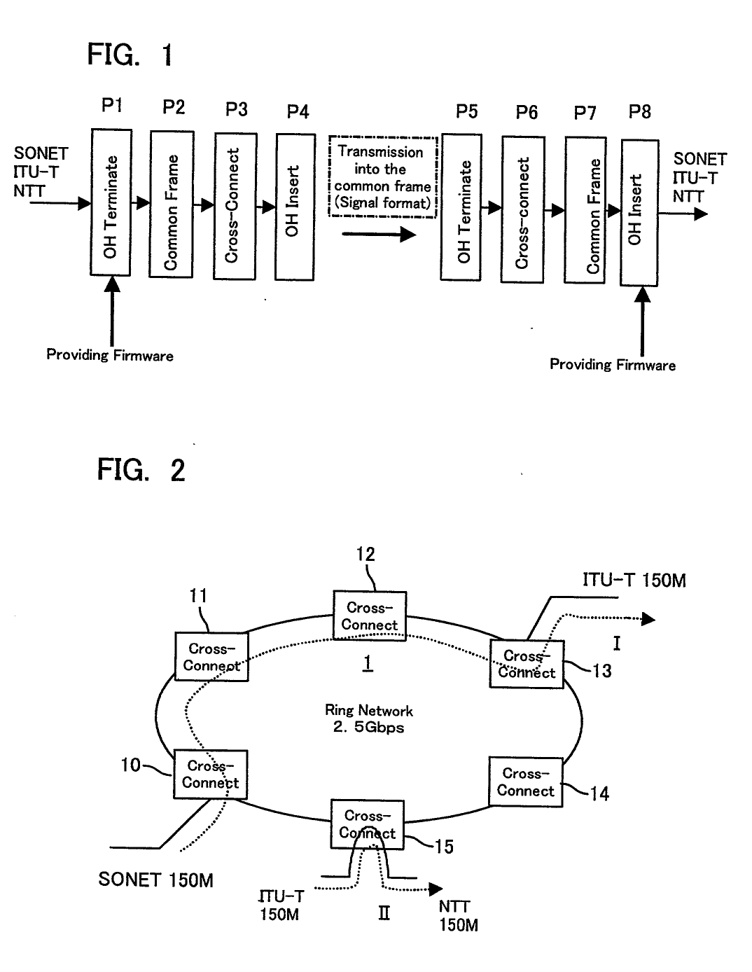

In FIG. 1, there is illustrated a chart indicating the processing sequence of transmission side and reception side in each transmission equipment. By providing appropriate firmware, a signal having any one interface among SONET interface, ITU-T interface and NTT interface can be received. The overhead of line signals received from a distant office is terminated here (process P1).

According to the present invention, the terminated overhead is converted to a common frame within the relevant network (process P2). Then, the frame is transferred to the cross-connected transmission equipment (process P3). An overhead is inserted into the common frame to be forwarded to a transmission line of the higher order group in the network (process P4).

On the other hand, an overhead of a signal transmitted through a network transmission line is terminated in a similar manner (process P5). The terminated overhead is then cross-connected (process P6) and a common frame in the network is converted into a signal frame having any one interface among SONET interface, ITU-T interface and NTT interface (process P7). Then, an overhead is inserted so that the frame is forwarded to the connected transmission equipment. After that, the frame is transmitted to a remote station using one interface among SONET interface, ITU-T interface and NTT interface (process P8).

Thus, according to the present invention, a logical path can easily be established by converting the interfaces with arbitrary combination, i.e. converting SONET interface into either ITU-T interface or NTT interface, converting ITU-T interface into either SONET interface or NTT interface, or converting NTT interface into either ITU-T interface or SONET interface.

In FIG. 2, there is shown an embodiment of a ring network which uses transmission equipment in accordance with the present invention, having processing function shown in FIG. 1. As an example, a plurality of transmission equipment 10 to 15 are connected in a ring network 1 having transmission speed of 2.5 Gbps. As shown in the figure, each transmission equipment provides cross-connecting function Xc.

Ring network 1 has its own common frame. For example, through ring network 1, a 150 Mbps signal having SONET interface inputted to transmission equipment 10 is forwarded to transmission equipment 13 as a 150 Mbps signal having ITU-T interface.

In this case, the 150 Mbps signal in a lower order group having SONET interface is converted into a common frame signal which is commonly used inside ring network 1 in transmission equipment 10, to multiplex into 2.5 Gbps signal. The multiplexed signal is then forwarded to transmission equipment 13 via ring network 1 by means of the cross-connecting function of transmission equipment 10, 11 and 12.

In transmission equipment 13, the received 2.5 Gbps signal is demultiplexed to convert into a low-speed signal of 150 Mbps in ITU-T signaling to output.

Furthermore, in transmission equipment 15, it is also possible to convert 150 Mbps signal of ITU-T interface into a signal of NTT interface to output.

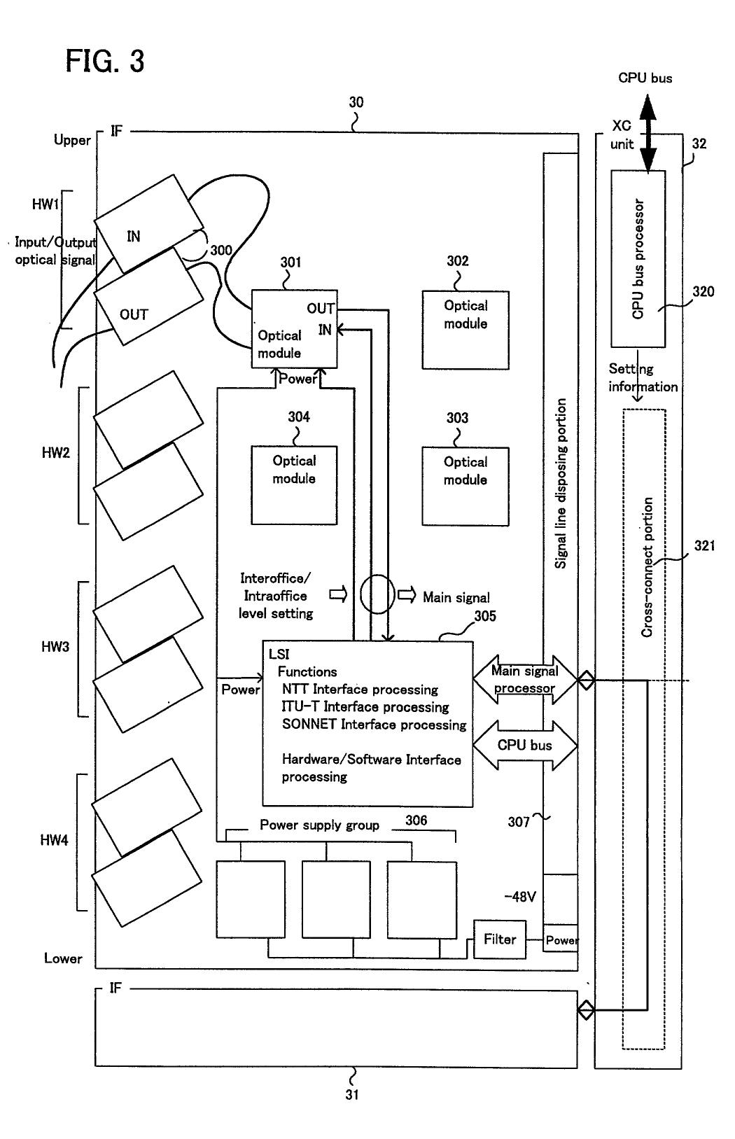

In FIG. 3, a configuration example of the above-mentioned transmission equipment is shown. The equipment includes a plurality of interface boards (IFs) 30 and 31, and a cross-connect unit (XC) 32 commonly provided to these interface boards.

Each plurality of interface boards (IFs) 30 and 31 is connected to the corresponding each plurality of main signal transmission lines HW1 to HW4 respectively through a connector 300 to input or output optical signals. A plurality of optical modules 301 to 304 is provided corresponding to a plurality of main signal transmission lines HW1 to HW4. For the sake of simplification, there is shown in FIG. 3 only the connection of optical module 301 with main signal transmission line HW1. Similarly, optical modules 302 to 304 are respectively connected to the corresponding main signal transmission lines HW2 to HW4.

Optical module 301 converts an optical signal input from main signal transmission line HW1 into an electric signal, or reversely converts an electric signal into an optical signal.

In FIG. 3, there is provided in each of interface boards 30 and 31 a main signal processor 305 configured by an LSI block which plays a main role in the transmission equipment. Main signal processor 305 provides functions of NTT interface processing, ITU-T interface processing and SONET interface processing, as well as processing function of interface between software and hardware.

There is also provided in the transmission equipment a power supply group 306 to supply power to a plurality of optical modules 301 to 304 and main signal processor 305.

Cross-connect unit 32 is connected to interface boards (IFs) 30 and 31 through a signal line disposing portion 307 by a connector. Cross-connect unit 32 is provided with a CPU bus processor 320 connected to a CPU bus to output setting information based on the information received from the CPU bus, and a cross-connect portion 321 provisioned to connect a plurality of interface boards (IFs) 30 and 31 based on the setting information received from CPU bus processor 320.

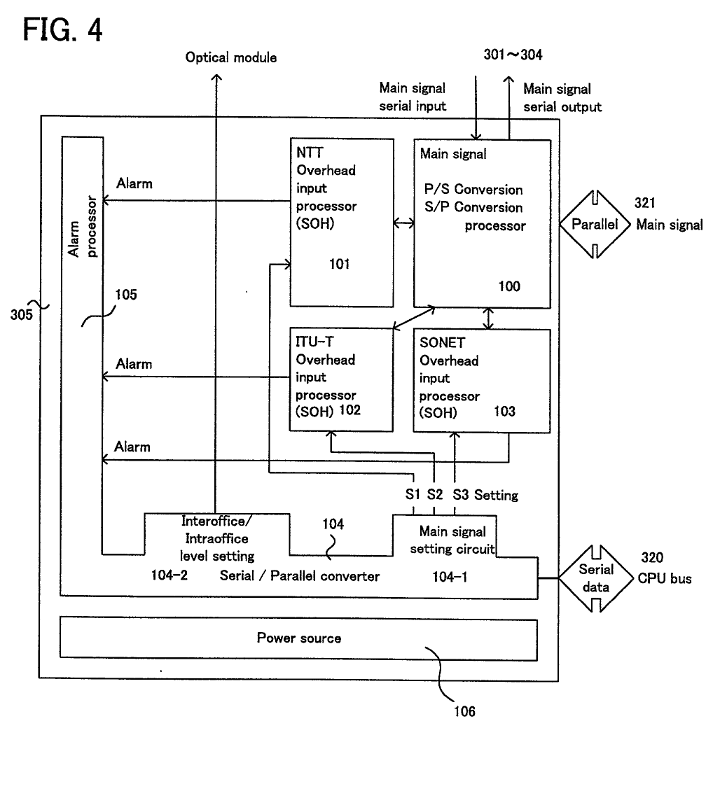

In FIG. 4, there is shown a block diagram illustrating a configuration example of the above-mentioned main signal processor 305, which includes a main signal processor 100 to send and receive serially a main signal to/from optical module 301.

Main signal processor 100 performs parallel-to-serial conversion or serial-to-parallel conversion respectively for outputting a serial main signal or for a serially inputted main signal. Moreover, main signal processor 100 sends or receives a parallel main signal to/from cross-connect portion 321, and also sends or receives a serial main signal to/from optical modules 301 to 304.

Furthermore, main signal processor 100 is connected to NTT overhead input processor 101, ITU-T overhead input processor 102, and SONET overhead input processor 103.

In main signal processor 305, there are provided a serial/parallel converter 104 which functions to process serial data sent or received to/from the CPU bus connected through CPU bus processor 320, and an alarm processor 105 connected thereto. A common power source 106 is also provided. Alarm processor 105 receives an alarm detected in the aforementioned NTT overhead input processor 101, ITU-T overhead input processor 102, or SONET overhead input processor 103.

Serial/parallel converter 104 includes a main signal setting circuit 104-1 for setting a main signal into predetermined position of a frame signal, and a level setting circuit 104-2 for setting a signal level corresponding to either interoffice communication or intraoffice communication.

Corresponding to NTT overhead input processor 101, ITU-T overhead input processor 102, or SONET overhead input processor 103, a function is provided for processing a logical part of the corresponding interface. According to a setting signal transmitted from CPU bus processor 320, a mode is selected to specify a particular processor for use among the above-mentioned input processors i.e. NTT overhead input processor 101, ITU-T overhead input processor 102, and SONET overhead input processor 103.

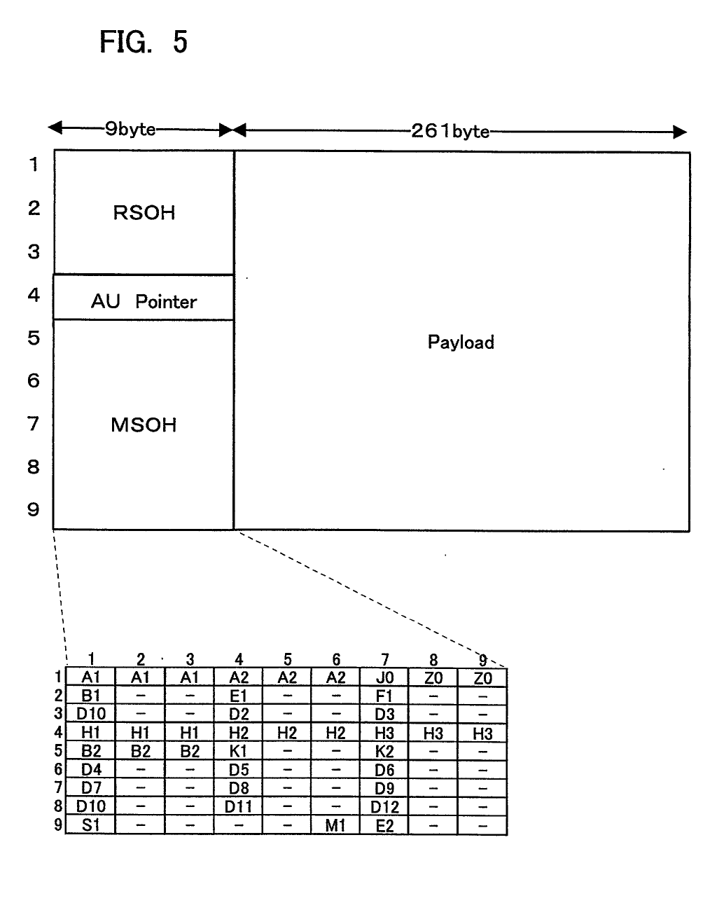

Hereafter a common format is described. In FIG. 5, a chart of signal frame structure is shown. A frame includes a header part consisting of 9×9 bytes and a payload part consisting of 261×9 bytes. In the lower part of FIG. 5, there is an enlarged chart showing reference symbols of bytes constituting the overhead part.

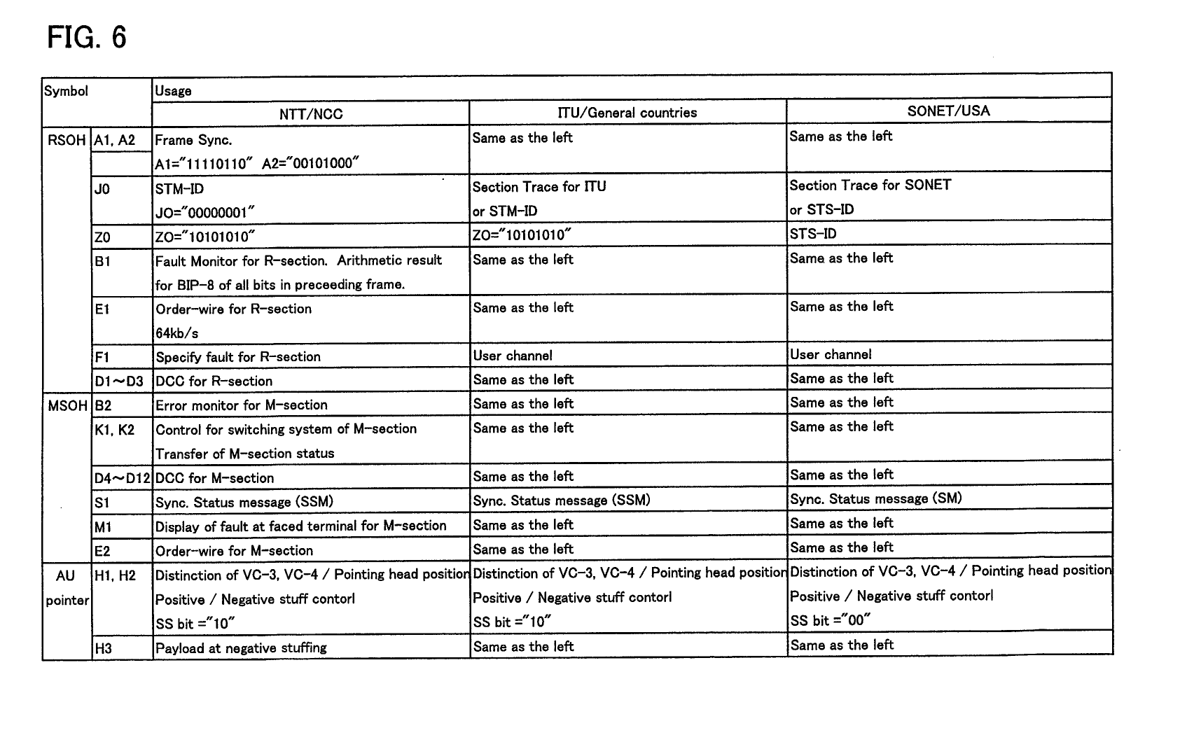

In FIG. 6, there is shown a chart for comparing the specifications on byte configuration of the overhead part of NTT interface for domestic use, ITU-T interface for general countries, and SONET interface used in the USA. As can be understood from this chart, the use for reference symbols in the overhead part bytes is largely common to all interfaces.

Therefore, in the present invention, only the reference symbols different among the interfaces are converted to the common definition by the corresponding input/output processors 101 to 103, so that the common format becomes usable.

Namely, a signal of each interface is converted from a signal based on the definition of use proper to respective interfaces into a signal based on the definition of use for reference symbols commonly defined within the ring network, in each corresponding input/output processor 101, 102 or 103.

For this purpose, the conversion logic is constituted by the built-in firmware in respective input/output processors 101, 102 and 103.

Main signal processor 100 generates a common frame signal from overhead bytes in a signal converted by one of input/output processors 101, 102 and 103, using the definition of use for reference symbols proper to each interface and the reference symbols common to each interface.

Here, when generating a common frame signal, which one of input/output processors 101, 102 and 103 is to be used is decided according to a predetermined network provisioning, and the result is set to main signal setting portion 104-1 in the following manner.

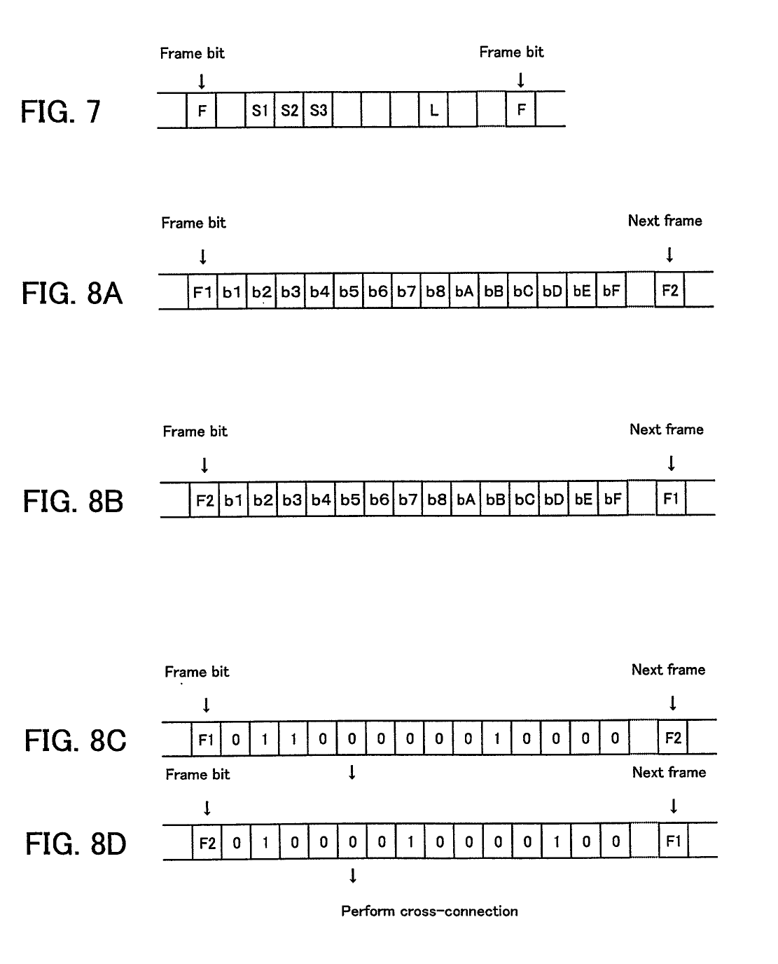

In FIG. 7, there is shown a serial data sent from CPU bus 320 to specify one of the input/output processors 101, 102 and 103 for use. S1 to S3 bits and L bit are assigned between frame bits F.

When ‘1’ is set on S1 bit in FIG. 7, NTT mode is set to specify NTT overhead input/output processor 101 for use. When ‘1’ is set on S2 bit, then ITU-T mode is set to specify ITU-T overhead input/output processor 102 for use. Similarly, when ‘1’ is set on S3 bit, SONET mode is set to specify SONET overhead input/output processor 103 for use.

Namely, in main signal setting circuit 104-1 of serial/parallel converter 104 shown in FIG. 4, one of the overhead input processors, i.e. NTT overhead input processor 101, ITU-T overhead input processor 102 or SONET overhead input processor 103, is specified for use corresponding to the aforementioned condition of S1 to S3 bits.

In FIG. 7, an interoffice level is used when L bit is ‘1’, while an intraoffice level is used when L bit is ‘0’. Depending on whether ‘1’ or ‘0’ is set on L bit in level setting circuit 104-2 of serial/parallel converter 104 , an output level of optical modules 301 to 304 is controlled. Thus, larger optical output level is set for interoffice level than for intraoffice level.

Now, provisioning connection setting in cross-connect portion 321 in FIG. 3 is explained hereafter. The originating line is set in advance in CPU bus processor 320 of cross-connect portion 321, based on the connection setting information received through the CPU bus. This is carried out in the following way.

In FIGS. 8A through 8D, a serial signal sent from the CPU bus is shown. An originating line is specified in the first frame shown in FIG. 8A. Namely, in FIG. 8A, whether or not the connection is made on a high-speed side is specified by b1. When b1=‘1’, the connection is made on the high-speed side.

Similarly, b2 specifies whether or not the connection is made on a low-speed side. When b2=‘1’, the connection is made on the low-speed side. Furthermore, bits b3 to bA specify which of the plurality of interface boards 30 and 31 has the originating line (i.e. the number of the interface boards).

Also, bits bB to bE show which of the plurality of main signal transmission lines HW is to be assigned as the originating line. The corresponding location of the bits is set to ‘1’ in either of the above cases.

Then, using the second frame shown in FIG. 8B, the connection line is specified. Namely, in FIG. 8B, b1 specifies whether or not the connection is made on a high-speed side. When b1=‘1’, the connection is made on the high-speed side. Similarly, b2 specifies whether the connection is made on a low-speed side or not. When b2=‘1’, the connection is made on the low-speed side.

Bits b3 to bA are used for specifying which of the plurality of interface boards 30 and 31 is to be connected. Also, bits bB to bE show which of the plurality of main signal transmission lines HW in the interface board is to be connected. The corresponding location of the bits is set to ‘1’ in either of the above cases.

Such frame bits are decided by CPU bus processor 320 to forward the corresponding setting information to cross-connect portion 321 to perform cross-connection function.

In FIGS. 8C and 8D, there is shown an example of connection setting according to FIGS. 8A and 8B. By the first frame shown in FIG. 8C, the first main transmission line HW1 in the first interface IF1 in the low-speed side is specified as the originating line. Also, by the second frame shown in FIG. 8D, the third main signal transmission line HW3 in the fifth interface IF5 is specified.

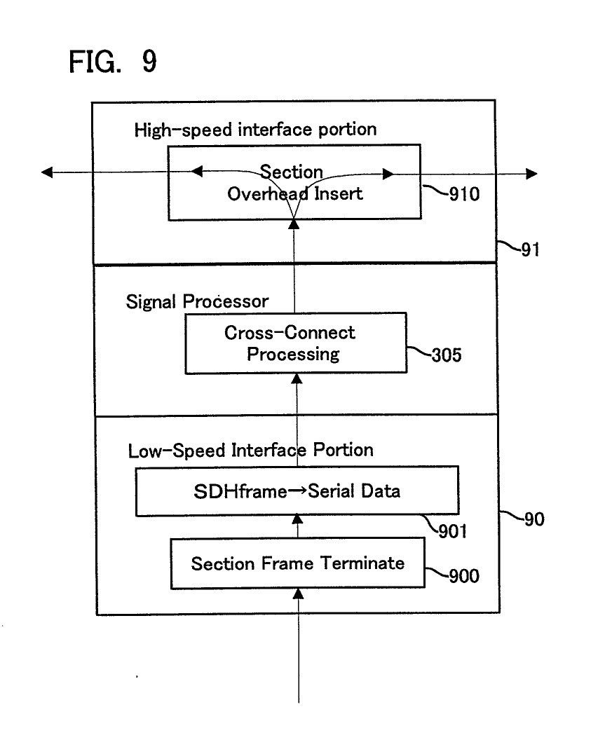

According to such connection setting described above, a process shown in FIG. 1 is executed in each transmission equipment. In FIGS. 9 to 11, examples of connection setting in the transmission equipment are shown. FIG. 9 shows an example of signal connection originated from a low-speed interface portion, forwarded to a high-speed interface portion on the network side.

A signal from the low-speed line is frame-terminated in low-speed interface portion 90 (900), then the frame signal is converted into a serial data (901).

The serial data is connected to high-speed interface portion 91 in the cross-connect of main signal processor 305, according to the provisioning connection setting explained before. In high-speed interface portion 91, an overhead common to the network is inserted to forward to the connected transmission equipment according to the provisioning connection setting (910).

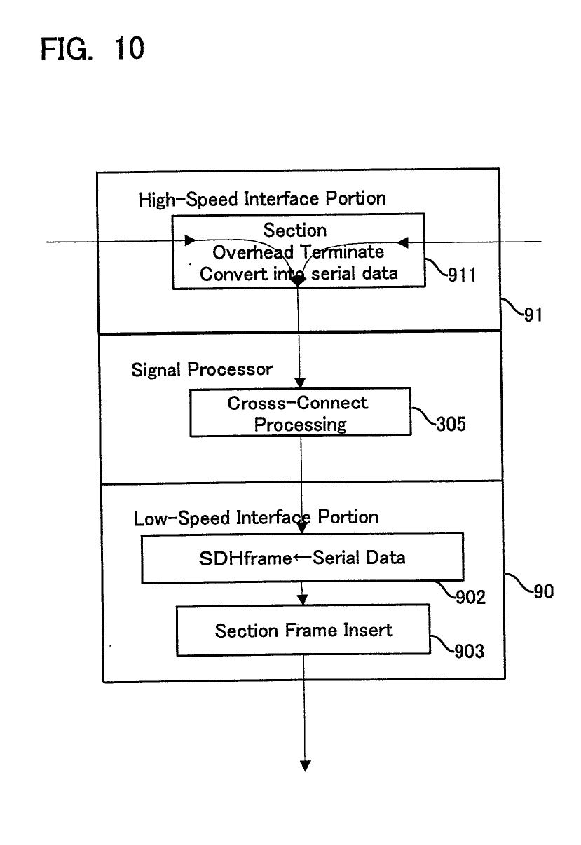

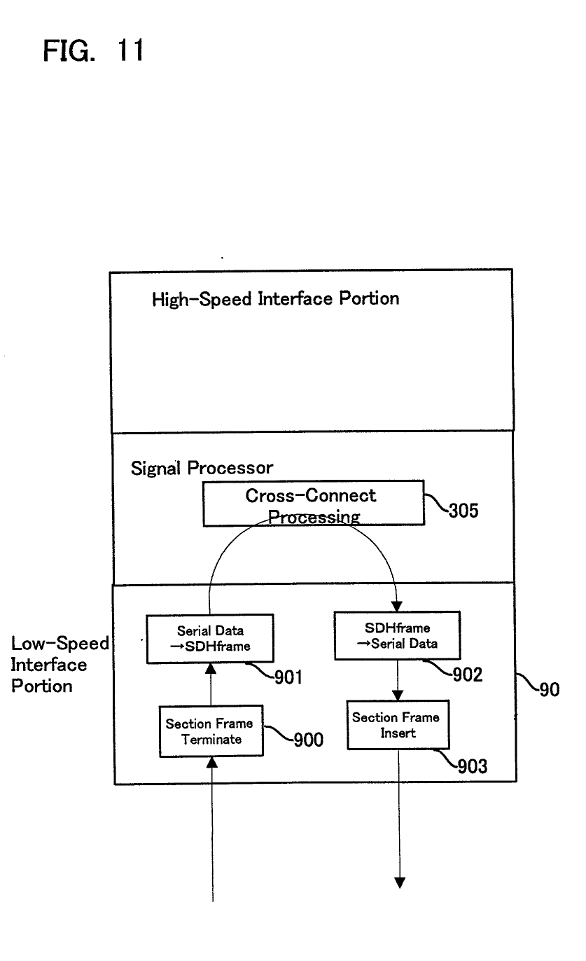

In FIG. 10, there is shown a signal forwarding from the network side to the low-speed interface portion 90, which is the opposite direction to the case in FIG. 9.

An overhead of signal received from the high-speed side is terminated in high-speed interface portion 91, to convert into serial data (911). The converted serial data is connected to low-speed interface portion 90 in cross-connect 305 in the signal processor according to the provisioning connection setting explained before.

In low-speed interface portion 90, the serial data is converted into an SDH frame signal (902), to forward to the connected transmission equipment according to the provisioning connection setting (903).

In FIG. 11, there is shown an example in which a signal from the low-speed line is turned back to another low-speed line . A frame is terminated in low-speed interface portion 90 (900), then the frame signal is converted into serial data (901).

The serial data is turned back to low-speed interface portion 90 in cross-connect 305 of the signal processor, according to the provisioning connection setting explained before. The turned-back serial data signal is converted into an SDH frame signal (902), to forward to the connected transmission equipment (903).

As the embodiment having been illustrated according to the accompanied drawings, the present invention enables to provide a system which avoids implementing independent networks each corresponding to individual communication interface.

According to the invention, a flexible interface design is facilitated for most domestic networks having any domestic and overseas interfaces per line basis. The present invention improves efficiency in line accommodation as well as in network designing.

The foregoing description of the embodiment is not intended to limit the invention to the particular details of the examples illustrated. Any suitable modification and equivalents may be resorted to the scope of the invention. All features and advantages of the invention which fall within the scope of the invention are covered by the appended claims.

What is claimed is:

1. A network system having a plurality of transmission equipment connected thereto, each transmission equipment comprising:
an interface for accommodating a plurality of low-speed transmission lines for transmitting a main signal, to transmit said main signal to a network according to a preset cross-connection, or to transmit said main signal received from said network to said plurality of low-speed transmission lines for transmitting said main signal; and
an interface processor for converting signal formats corresponding to interfaces of said main signal into a format commonly defined in said network.

2. Transmission equipment connected to a network, comprising:
an interface for accommodating a plurality of low-speed main signal transmission lines, to transmit main signal to said network according to a preset cross-connection, or to transmit a main signal received from said network to said plurality of low-speed main signal transmission lines; and
an interface processor for converting a signal format corresponding to an interface of said main signal into a signal format common to said network.

3. Transmission equipment connected to a network, comprising:
an optical module for transmitting or receiving an optical main signal;
an interface processor corresponding to a plurality of communication interfaces;
a cross-connect for connecting said main signal to a predetermined connection line;
a CPU bus processor for providing said interface processor with a setting signal specifying one of said plurality of interfaces for use, and for providing said cross-connect with a cross-connection signal to set a connection line of said main signal.

4. The transmission equipment according to claim 3, wherein said CPU bus processor provides said interface processor through said CPU bus with a level setting signal to change light emission level of said optical module depending on whether the connection is intraoffice connection or interoffice connection.

5. The transmission equipment according to claim 4, wherein said interface processor includes:
a main signal processor for performing serial-to-parallel conversion of a main signal, or performing parallel-to-serial conversion thereof; and
a plurality of overhead input/output processors provided corresponding to a plurality of interfaces, for converting definition of use for reference symbols proper to each interface into a signal of which format is common to said network.

6. The transmission equipment according to claim 5, wherein said plurality of interfaces include NTT interface, ITU-T interface, and SONET interface.
